(19) United States
(12) Patent Application Publication
(10) Pub. No.: US 2015/0292660 A1
(43) Pub. Date: Oct. 15, 2015

(54) PIPE FITTING

(71) Applicant: Freeflow, LLC, Bluffdale, UT (US)

(72) Inventors: Robert Mathews, Bluffdale, UT (US); Howard Mecham, Murray, UT (US); Kenneth Sykes, Bluffdale, UT (US)

(21) Appl. No.: 14/481,726

(22) Filed: Sep. 9, 2014

Related U.S. Application Data
(63) Continuation-in-part of application No. 14/253,052, filed on Apr. 15, 2014.

(51) Int. Cl. F16L 29/00; F16K 3/02

(52) U.S. Cl. CPC F16L 29/007; F16K 3/0281

(57) ABSTRACT

A pipe fitting comprises a number of orifices defined in a number of connecting ends, a gate housing dividing the pipe fitting into a first section and a second section, a gate disposed within the gate housing to selectively seal the first section from the second section, and a gate plug to selectively seal the gate housing upon removal of the gate from the gate housing.

### RELATED DOCUMENTS

The present application is a continuation-in-part, and claims the benefits under 35 U.S.C. §120, of U.S. application publication Ser. No. 14/253,052, filed Apr. 15, 2014. This application is herein incorporated by reference in their entireties.

### BACKGROUND

The present application relates to pipe fittings used in the construction of new buildings or the renovation of the plumbing and water systems of existing buildings. Pipe fittings provide the ability to link two straight pipe sections together. In some circumstances, it is necessary to perform testing and inspections on plumbing systems at these fittings and throughout the pipe system to ensure that the pipe system is properly installed and meets the requirements of local building code. Existing pipe fittings are cumbersome during the performance of building inspections, requiring the use of a significant amount of time, equipment, and specialized training.

### BRIEF DESCRIPTION OF THE DRAWINGS

The accompanying drawings illustrate various examples of the principles described herein and are a part of the specification. The examples do not limit the scope of the claims.

FIG. 1 is a perspective, exploded view of a pipe fitting, according to one example of principles described herein.

FIG. 2 is a side view of the pipe fitting of FIG. 1 with the gate in an opened position, according to one example of principles described herein.

FIG. 3 is a side view of the pipe fitting of FIG. 1 with the gate in a closed position, according to one example of principles described herein.

FIG. 4 is a side view of the pipe fitting of FIG. 1 with the gate in the opened and bent position, according to one example of principles described herein.

FIG. 5 is a front cut-away view of the pipe fitting of FIG. 1 along line “A” of FIG. 2, according to one example of principles described herein.

FIG. 6 is a front perspective, exploded view of a pipe fitting, according to one example of principles described herein.

FIG. 7 is a side view of the pipe fitting of FIG. 7 with the gate plug in the closed position, according to one example of principles described herein.

FIG. 8 is a front cut-away view of the pipe fitting of FIG. 6 with the gate in the closed position along line “A” of FIG. 7, according to one example of principles described herein.

FIG. 9 is a front cut-away view of the pipe fitting of FIG. 6 with the gate plug inserted along the line “A” of FIG. 7, according to one example of principles described herein.

FIG. 10 is a side view of the pipe fitting of FIG. 6 with the gate in the closed position, according to one example of principles described herein.

FIG. 11 is a side view of the pipe fitting of FIG. 6 with the gate removed from the pipe fitting, according to one example of principles described herein.

FIG. 12 is a side view of the pipe fitting of FIG. 6 with the gate plug inserted, according to one example of principles described herein.

FIG. 13 is a front perspective view of the pipe fitting of FIG. 1 which uses standard size couplers, according to one example of principles described herein.

Throughout the drawings, identical reference numbers designate similar, but not necessarily identical, elements.

### DETAILED DESCRIPTION

As briefly described above, pipe fittings provide the ability to link two pipe sections together. These pipes may connect complex systems that are inspected individually before being joined. The drain line between a building and an existing pipe supplied by a developer are one example of this. The existing style of fitting used between a new building's drain line and the existing line requires a method of inspection that can be cumbersome, time consuming, and requires specific equipment to perform. This equipment, for example, includes a gasket test tee, a test ball, a push-in cap, and a device to pump air into the test ball.

The present pipe fitting eliminates the need for the testing equipment described above. This pipe fitting, therefore, simplifies the pipe system inspection process, and greatly decreases costs to contractors, sub-contractors, property owners, and others involved in the building and purchasing of the building in which the present pipe fitting is installed. In one example, the pipe fitting is made of a clear material. This allows for a building inspector to determine that fluids such as water is flowing and present in the system, without needing to use the gasket test tee, test ball, push in cap, and device to pump air into the test ball described above. The pipe fitting comprises a gate located near the center of the fitting. The gate, when closed, prevents fluids from flowing and allows the system on either the upstream side or downstream side of the pipe system with respect to the pipe fitting to pressurize and ensure that there are no leaks. When the gate is opened, fluid is allowed to flow freely through the pipe system. In one example, the gate may be locked in the open position and/or the closed position. This locking may enable the user of the pipe fitting to perform an inspection processes any number of times.

In one example, the gate may be bent or folded from a vertical position to a horizontal position with respect to a portion of the gate. The bend may occur at a manufactured breakaway (112) engineered in the gate. In one example, the manufactured breakaway (112) may be a living hinge. A living hinge is a thin flexible hinge or flexure bearing. In this example, the living hinge may be made from the same material as the two pieces it connects. A living hinge may be manufactured by thinning or cutting material to allow the two pieces to bend with respect to one another along the line of the living hinge. A living hinge imparts minimal friction and very little wear in the overall system. Further, the living hinge may be manufactured at a relatively lower cost than other forms of hinges and with relatively easier manufacturing processes.

In one example, the manufactured breakaway (112) may be engineered to permanently bend the gate with respect to the pipe fitting. In this example, the manufactured breakaway (112) is comprised of a material or formed with the ability to elastically bend and deform without breaking the connection between the two sections of the gate. In another example, the manufactured breakaway may be engineered to non-permanently bend the gate with respect to the pipe fitting. In one example, once bent at the manufactured breakaway, the gate may be left indefinitely. In that position, the pipe system including the pipe fitting may be back filled to cover the pipe system. The dirt filled over the pipe fitting fills over the bent gate, and secures the gate in that position.

The present application, therefore, describes a pipe fitting comprising a number of orifices defined in a number of connecting ends, and a gate housing dividing the pipe fitting into two sections. Further, a gate is included within the gate housing to selectively seal approximately one half of the pipe fitting from the other.

The present application further describes a pipe fitting comprising a number of orifices defined in a number of connecting ends, and a gate housing dividing the pipe fitting into two sections. The present application further describes a pipe fitting comprising a gate housing dividing the pipe fitting into two sections, and a gate within the gate housing to selectively seal one side from another.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language indicates that a particular feature, structure, or characteristic described in connection with that example is included as described, but may not be included in other examples.

In the present specification and in the appended claims, the term “pipe fitting” is meant to be understood broadly as a device used in a pipe system to connect pipe or tubing sections. In one example, pipe fittings may adapt to different sizes or shapes of pipes, and may regulate or measure fluid flow. Although the present application describes a pipe fitting that is used to interface between the drain line of an existing sewer system and a commercial or residential building, there may be other examples in which the present pipe fitting may be applied and used.

Additionally, as used in the present specification and in the appended claims, the term “a number of” or similar language is meant to be understood broadly as any positive number comprising 1 to infinity; zero not being a number, but the absence of a number.

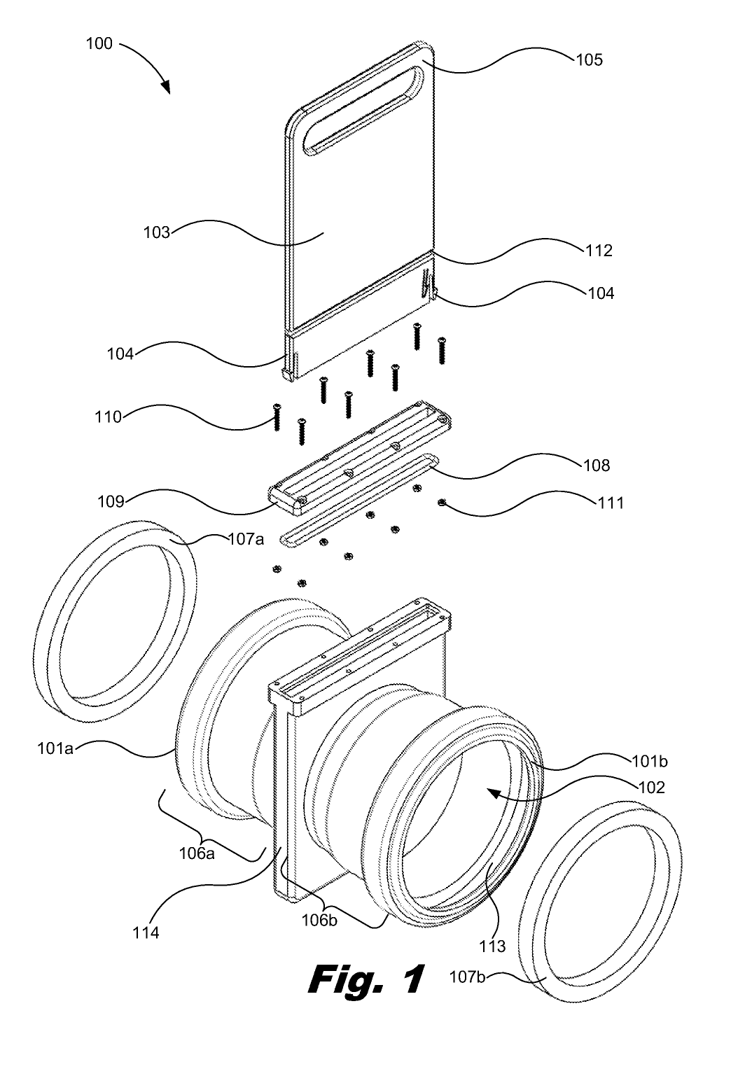

Turning now to the figures, FIG. 1 shows a front perspective, exploded view of a pipe fitting (100), according to one example of principles described herein. The pipe fitting (100) may be made of any material including, for example, clay, metals and metal alloys such as brass, copper, and cast iron, polyvinyl chloride (PVC), chlorinated polyvinyl chloride (CPVC), unplasticized polyvinyl chloride (UPVC), polypropylene (PP), polyethylene (PE), low density polyethylene (LDPE), high density polyethylene (HDPE), polyvinylidene fluoride (PVDF), or acrylonitrile butadiene styrene (ABS), among other types of materials.

In another example, the pipe fitting (100) may be made of a transparent material to allow for the inspection of the flow of fluids through the pipe fitting (100) as will be described in more detail below. In this example, that transparent material allows the interior cavity of the pipe fitting (100) to be visually inspected from the exterior of the pipe without the use of specific tools. With the gate (103) in the closed position, it is possible to inspect the upstream or downstream systems connected to the pipe fitting (100) for leaks, visually confirming that fluid such as water has reached the pipe fitting and is not leaking from any joints in the pipe systems. In another example, the pipe fitting (100) may be made of an opaque material.

The material used to construct the pipe fitting (100) may be a material sufficiently strong to withstand an interior pressure necessary for a pressurized plumbing system. In one example this may be at least 5 pounds per square inch (psi), which is a standard pressure used in inspection of blackwater and greywater sewage systems as to several local ordinances. In another example, the maximum pressure may be more or less. In still another example, the material used to construct the pipe fitting (100) may be a schedule 5, 10, 20, 30, 40, 60, 80, 100, 120, 140, or 160 pipe fitting.

In yet another example, the length of pipe (101) may be constructed of a non-transparent material, with a clear viewing section or window built into a portion of the pipe fitting (100) to allow for external visual inspection of the interior of the pipe fitting (100).

A pipe fitting (100) may comprise a number of connecting ends (101a, 101b) referred herein collectively as 101. The connection ends (101) comprise pipe orifices (102) defined therein to receive lengths of pipe to which the pipe fitting (100) is coupled, and that couple a number of lengths of pipe. One pipe orifice (102) is depicted in FIG. 1, however, each connection end (101) comprises a pipe orifice (102) defined therein.

A gate housing (114) may be located between the connecting ends (101) of the pipe fitting (100). The gate housing (114) houses a gate (103) to seal a first section (106a) of the pipe fitting (100) from a second section (106b), and to prevent fluid from flowing through the pipe fitting (100). The gate housing (114) may comprise a gate housing top (109), a number of gate gaskets (108), a number of gate housing screws (110), and a number of gate housing nuts (111). The gate housing (114) will be described in further detail below.

The gate (103) comprises a gate handle (105), a number of gate latches (104), and a manufactured breakaway (112), each of which will be described in more detail below. The pipe fitting (100) may further comprise a number of pipe sections (106a, 106b) referred herein collectively as 106. The pipe sections (106) may be of equal or unequal length. Each pipe section (106) comprises a pipe orifice (102) defined therein.

The pipe sections (106), as described above, comprise a pipe orifice (102) defined therein, and located to either side of the gate housing (114). In one example, the pipe sections (106) may comprise the connecting ends (101a, 101b). The connecting ends (101) may selectively couple to an external length of pipe or an overall pipe system. The connecting ends (101) may be permanently attached to the external length of pipe. In one example, the pipe fitting (100) may be a compression fitting. In a compression fitting, the connecting ends (101) are joined to lengths of pipe via a number of gaskets (107a, 107b) referred herein collectively as 107. The connecting ends (101) may comprise a number of gasket recesses (113) defined within the pipe sections (106). The gasket recess (113) house a number of pipe gaskets (107). In one example, the pipe gaskets (107) may be used to further ensure a hermetic seal between the connecting end (101) and a length of pipe.

In another example, the permanent connection may be provided through the application of a chemical bonding agent such as, for example, solvent cements. In another example, the permanent connection may be provided through a heat-fusion process such as butt-fusion process. In these examples, the connecting ends (101) may be formed in a different manner to provide a portion of the connecting ends (101) to abut the lengths of pipe directly.

The pipe fitting (100) discussed herein may be formed to couple with any diameter, length, or size of pipe. Thus, the connecting ends (101a, 101b) may be of any diameter to couple with any diameter, length, or size of pipe. Some examples of the diameters of the connecting ends (101a, 101b) may be %, %, 1, 1%, 1%, 2, 2 %, 3, 4, 5, 6, 8, 10, 12, 14, and 16 inch diameters. In one example, the diameter of the first connecting end (101a) may be different from the diameter of the second connecting end (101b). In another example, the material thickness of the connecting ends (101) may be any thickness necessary to perform the function of containing a reasonable pressure distributed evenly throughout the inside of the pipe system.

The gate housing (114) as described above, may comprise a gate housing top (109), a number of gate gaskets (108), a number of gate housing screws (110), and a number of gate housing nuts (111). In one example, the gate housing top (109) may secure over the gate (103) to secure the gate (103) within the gate housing (114). In one example, a number of gate housing screws (110) and a number of gate nuts (111) may be used to secure the gate housing top (109) to the gate housing (114). In one example, a number of gate gaskets (108) may be located between the gate (103) and the gate housing (114) to hermetically seal the junction between the gate (103) and the gate housing (114). In another example, the gate screws (110) may be replaced with a chemical bonding agent or glue that may secure the gate housing top (109) to the gate housing (114). In still another example, the gate housing top (109) and the gate housing (114) may be coupled using a number of latches, clamps, rivets, screws, or other forms of fasteners.

The gate (103), as described above, comprises a gate handle (105), a number of gate latches (104), and a manufactured breakaway (112). In one example, the gate handle (105) may be located near the top of the gate, in a location that allows a user to pull upwards or push downwards on the gate handle (105) to move the entire gate (103) vertically within the gate housing (114). The gate handle (105) is capable of supporting sufficient force such that the force the gate latches (104) provide in securing the gate (103) in an open or closed position within the gate housing (114) is overcome. In one example, the gate latches (104) may be spring clips that provide a spring bias in the direction of engagement with the gate housing (114) as will be described in more detail below. In one example, the gate latches (104) may be located near the bottom of the gate (103) on either side of the gate (103). In one example, the gate latches (104) are biased in an outward direction with respect to the gate (103) to create a force on the inner walls of the gate housing (114). In this manner, the gate latches (104) secure the gate (103) in a number of positions such as, for example, an open position, a closed position, or a position intermediary to opened and closed.

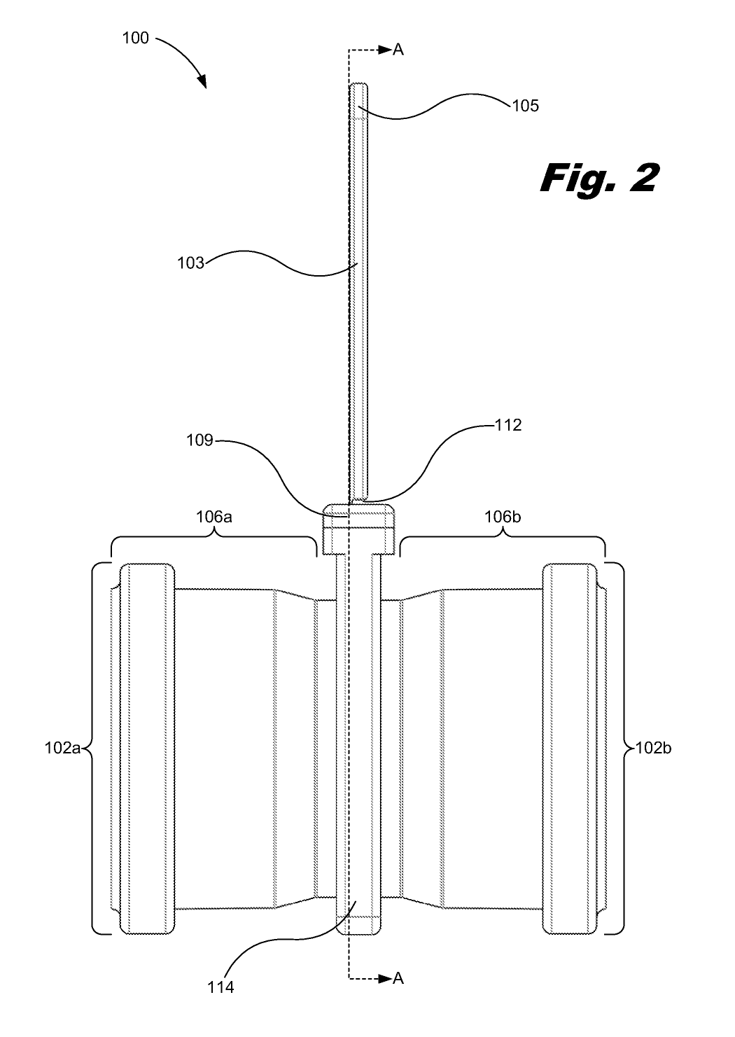

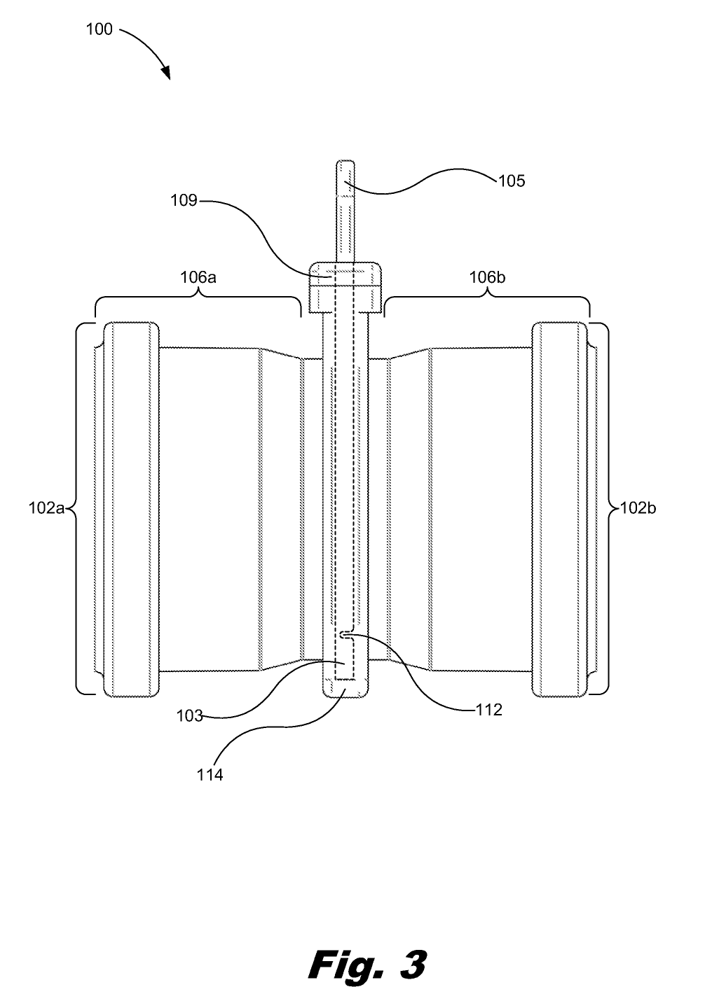

FIG. 2 is a side view of the pipe fitting (100) of FIG. 1 with the gate in an opened position, according to one example of principles described herein. An open position refers herein to the gate (103) being clear of the pipe orifice (102) and not obstructing the flow of fluids from the first section (106a) of the pipe fitting (100) to the second section (106b). In contrast, FIG. 3 is a side view of the pipe fitting (100) of FIG. 1 with the gate in a closed position, according to one example of principles described herein. A closed position refers herein to the gate being positioned to obstruct the flow of fluids from the first section (106a) of the pipe fitting (100) to the second section (106b), and to ensure the gate (103) forms a hermetic seal between the first section (106a) of the pipe fitting (100) to the second section (106b) with respect to the gate housing (114). As depicted in FIG. 3, the gate (103) is partially depicted in ghost using dashed lines to demonstrate how the gate (103) moves and seats within the gate housing (114). This hermetic seal between the first section (106a) of the pipe fitting (100) to the second section (106b) with respect to the gate housing (114) may be further accomplished through the use of a number of gate gaskets (108) as will be described in more detail below.

An intermediary position refers herein to the gate being positioned between an open position and a closed position. In either the open or the closed positions, the gate latches (104) may secure into a number of recesses defined in the gate housing (114) to lock the gate (103) in the respective positions.

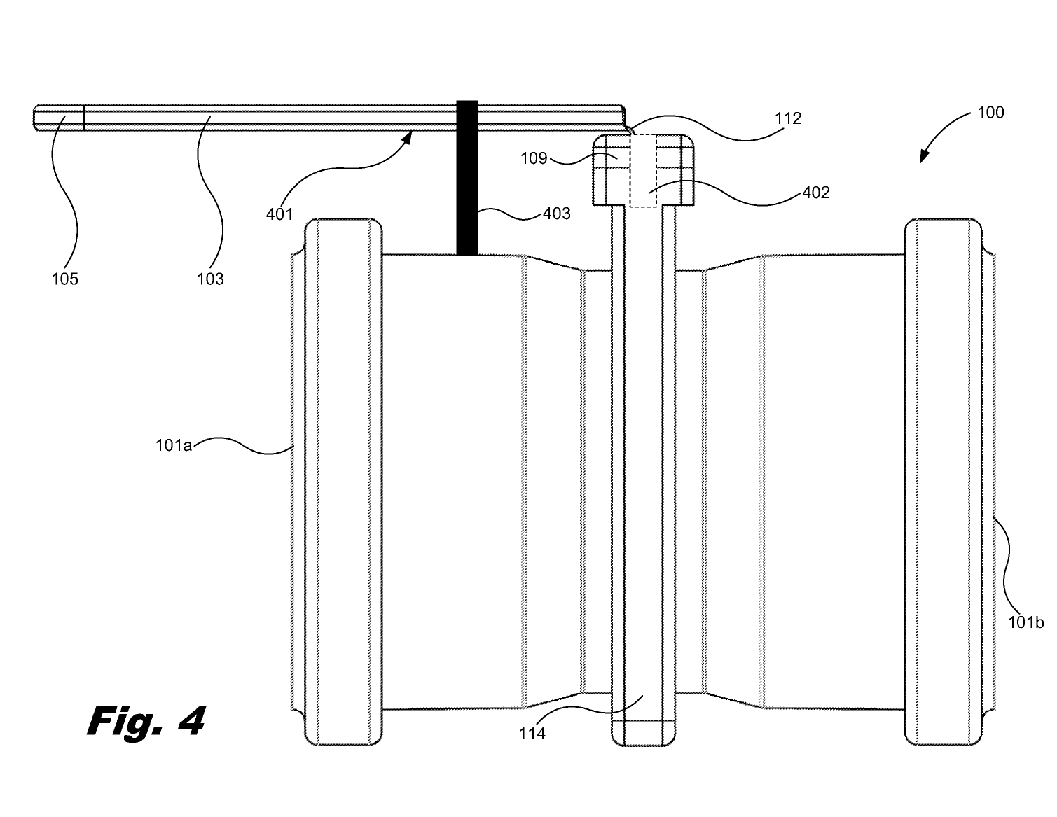

FIG. 4 is a side view of the pipe fitting (100) of FIG. 1 with the gate in the opened and bent position, according to one example of principles described herein. During, for example, inspection of the hermetical soundness of the pipe system in which the pipe fitting (100) is coupled, the user may open and close the gate (103) as depicted in FIGS. 2 and 3 any number of times. This provides the advantage of allowing the user to perform any number of tests on the pipe system to ensure that no leaks in the pipe system exist and to demonstrate to an inspector or other individual that the pipe system is hermetically sealed.

Once testing of the hermetical soundness of the pipe system is complete, the gate (103) of the pipe fitting (100) may be bent over as depicted in FIG. 4. In one example, the bend may occur at a manufactured breakaway (112) engineered in the gate (103). In one example, the manufactured breakaway (112) may be engineered to permanently bend the gate (103) with respect to the pipe fitting (100). In another example, the manufactured breakaway (112) may be engineered to non-permanently bend the gate (103) with respect to the pipe fitting (100). The manufactured breakaway (112) separates the gate (103) to form a first end (401) and a second end (402). The first end (401) comprises the handle (105). The second end (402), depicted in FIG. 4 in ghost using dashed lines, remains housed in the gate housing (114). The retention of the second end (402) in the gate housing (114) ensures that fluids flowing through the pipe fitting (100) do not exit out the top of the gate housing top (109). The gate gasket (108) sealing the gate housing top (109) to the gate housing (114) ensures that fluids do not exit the pipe fitting (100) between the second end (402) and the gate housing (114).

In one example, once bent at the manufactured breakaway (112), the gate (103) may be left indefinitely. In that position, the pipe system including the pipe fitting (100) may be back filled to cover the pipe system. The dirt filled over the pipe fitting (100) fills over the bent gate (103), and secures the gate (103) in the bent position. In this manner, the second end (402) of the gate (103) cannot be pushed down into the pipe fitting (100) after the gate (103) has been bent. The gate latches also ensure that the second end (402) of the gate (103) is not pushed down into the pipe fitting (100).

In one example, the manufactured breakaway (112) is engineered to allow for the bending of the gate (103) with respect to the pipe fitting (100) such that the first end (401) and second end (402) are not completely or permanently uncoupled from one another. This ensures that the second end (402) of the gate (114), if otherwise uncoupled from the first end (401), does not fall into the gate housing (114), and allow fluids to exit the opening of the gate housing top (109) of the gate housing (114).

In still another example, the manufactured breakaway (112) is engineered to allow for the bending of the gate (103) with respect to the pipe fitting (100) such that the first end (401) and second end (402) may be completely or permanently uncoupled from one another. In this example, the second end (402) of the gate (114) is secured by the gate latches (104) in the open position. In this manner, the second end (402) does not fall into the gate housing (114) and allow fluids to exit the opening of the gate housing top (109) of the gate housing (114).

In another example, the pipe fitting (100) may further comprise a retention latch (403). The retention latch (403) may be secured to a portion of the pipe fitting (100) such as, for example, one of the pipe sections (106a, 106b). The retention latch (403) may selectively secure the gate (103) in the bent position. In this manner, the retention of the gate (103) in the bent position and the second end (402) in the gate housing (114) ensures that the gate (103) does not fall into the gate housing (114) and fluids flowing through the pipe fitting (100) do not exit out the top of the gate housing top (109).

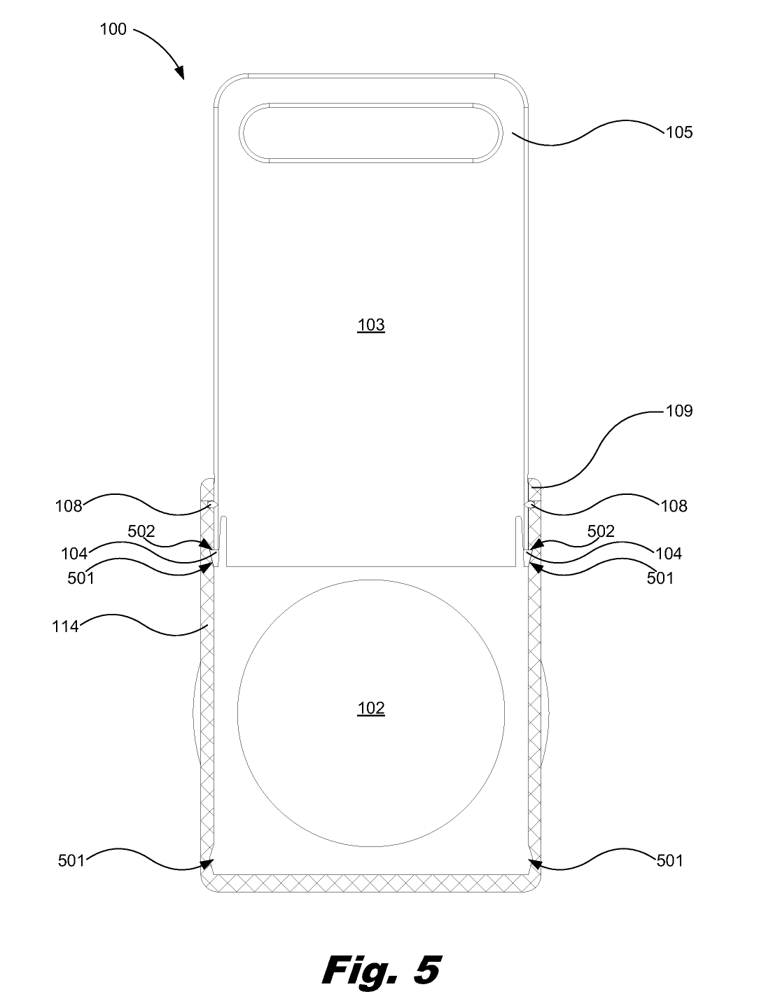

FIG. 5 is a front cut-away view of the pipe fitting (100) of FIG. 1 along line “A” of FIG. 2, according to one example of principles described herein. As depicted in FIG. 5, a number of gate latches (104) secure the gate (103) in an open or closed position within the gate housing (114). The gate latches (104) are biased in an outward direction with respect to the gate (103) to create a force on the inner walls of the gate housing (114). A number of gate latch recesses (501) may be defined within the interior of the gate housing (114). The gate latch recesses (501) assist in securing the gate in an opened or closed position. In one example, any number of gate latch recesses (501) may be defined in the interior of the gate housing (114). In this example, the gate (103) may be secured at any intermediary positions in addition to the opened and closed positions. This may allow for a relatively small amount of fluid to move through the pipe system.

In one example, the gate latch recesses (501) used to secure the gate (103) in an open position may be formed differently with respect to the gate latch recesses (501) used to secure the gate (103) in a closed or intermediate position. The gate latch recesses (501) used to secure the gate (103) in an open position may comprise an upper stopping edge (502). This upper stopping edge (502) ensures that the gate latches (104) cannot be disengaged from the gate latch recesses (501) used to secure the gate (103) in an open position. This also ensures that the gate (103) cannot be removed from the gate housing (114).

As described above, the gate latches (104) secure the gate (103) in a number of positions such as, for example, an open position, a closed position, or a position intermediary to opened and closed. The user may move the gate (103) from these various positions by overcoming the spring bias provided by the gate latches (104).

As discussed above, the pipe fitting (100) may be constructed of a clear or transparent material. In this example, with the gate (103) in an open, closed, or intermediate position, it will be possible to verify through visual inspection that fluid is or is not flowing freely through the pipe fitting (100). In this manner, an inspector, for example, may verify that the pipe system is hermetically sealed and otherwise in compliance with a number of standards and regulations.

The specification and figures describe a pipe fitting that allows the user to link two plumbing systems together and to test the integrity of those systems without additional equipment. The transparent construction of the device allows for a visual inspection, and the gate (FIG. 1, 103) allows the pipe sections (106) to be selectively isolated and hermetically sealed from one another. By pressurizing the system with the gate (103) closed, the user may verify the integrity of the attached system. By opening the gate (103), the user may verify the flow of fluid through the system by visual inspection by looking through the transparent pipe fitting (100). The user may also fold the gate (103) down to minimize its profile. At no point in time will the hermetic seal between the gate (103) and the gate housing (114) be compromised. The connecting ends (101) may also hermetically seal with the existing pipe systems on either side, either through physical or chemical means. This pipe fitting (100) may have a number of advantages, including the ability to test a drain waste vent system without the need for specialized equipment.

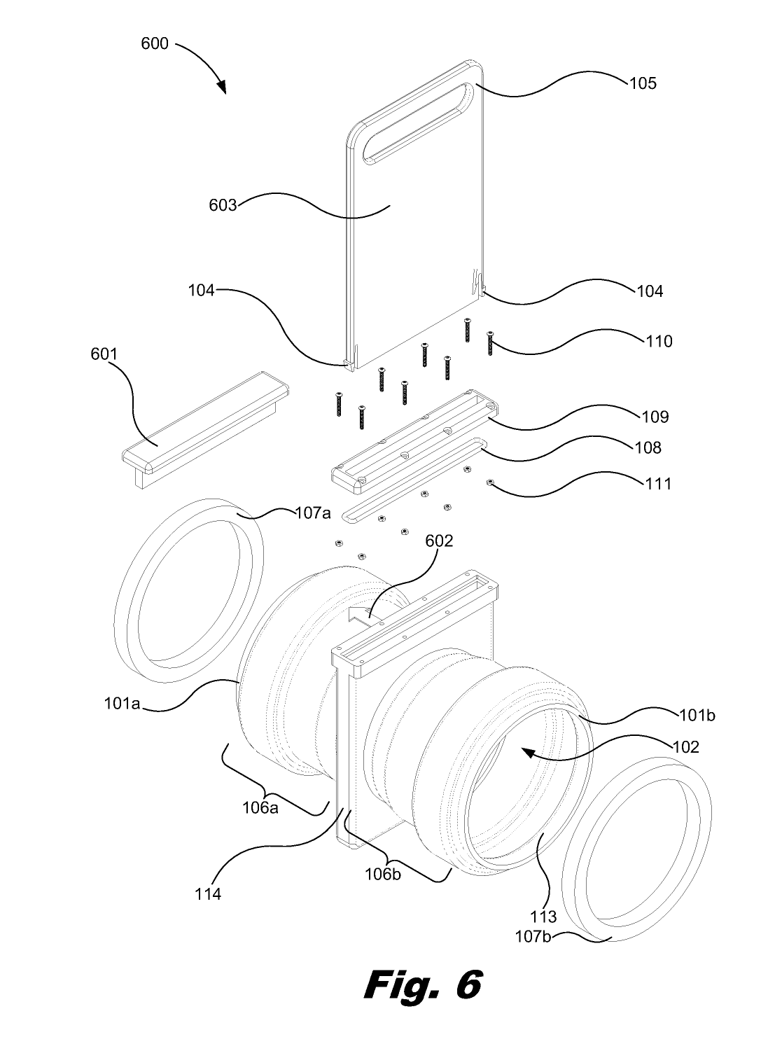

FIG. 6 shows a front perspective, exploded view of a pipe fitting (600) according to another example of principles described herein. Many of the principles of the example shown in this figure are similar or the same as those shown in FIG. 1, with some exceptions. In this example, the gate (103) may not comprise the manufactured breakaway (112) present in previous examples described herein. The gate (103) in this example may be a solid gate (603) which may be completely removed from the gate housing (114) to allow for a gate plug (601) to be inserted into the place of the solid gate (603). The solid gate (603) may not have a manufactured breakaway (112) yet may have other similar features as the gate (103) described above, such as the gate latches (104), gate handle (105), and may be sealed with respect to the gate housing (114) similarly by a gate gasket (108).

The solid gate (603) comprises a number of gate latches (104) which may be used to lock the solid gate (603) in an open position, closed position, or intermediary position in much the same way as the gate (103) described above. The gate latches (104) are biased in an outward direction with respect to the gate (103) to create a force on the inner walls of the gate housing (114). A number of gate latch recesses (501) may be defined within the interior of the gate housing (114). The gate latch recesses (501) assist in securing the gate in an opened or closed position. In one example, any number of gate latch recesses (501) may be defined in the interior of the gate housing (114). In this example, the gate (103) may be secured at any intermediary positions in addition to the opened and closed positions.

In one example, the gate latch recesses (501) used to secure the solid gate (603) in an open position may be formed differently with respect to the gate latch recesses (501) used to secure the solid gate (603) in a closed or intermediate position. The gate latch recesses (501) used to secure the solid gate (603) in an open position may comprise an upper stopping edge (502). This upper stopping edge (502) ensures that the gate latches (104) will not be disengaged from the gate latch recesses (501) used to secure the solid gate (603) in an open position unless an external force from the user is applied. This also allows for the user to remove the solid gate (603) from the gate housing (114) if sufficient force is applied. The solid gate (603) may remain locked in the open position, and may also be removed from the gate housing (114) with sufficient force.

The gate plug (601) may be inserted into the void defined in the gate housing (114) which remains after the removal of the solid gate (603) and creates a hermetic seal with respect to the gate housing (114). To create this seal, the gate plug (601) may use the same gate gasket (108) used by the solid gate (603) in one example, or may use a new gate gasket (108) provided by the gate plug (601). In another example, the gate plug (601) may be coupled to the gate housing (114) through chemical bonding, butt-fusion processes, or through application of a number of coupling devices such as clamps, screws or other forms of coupling devices.

A directional indicator (602) may also be displayed in this example, or any other example described herein. The directional indicator (602), in one example, may be an arrow which indicates the direction which water will flow from one side of the gate to the other, and may indicate the downstream direction. This directional indicator (602) may be included in any of the examples described previously.

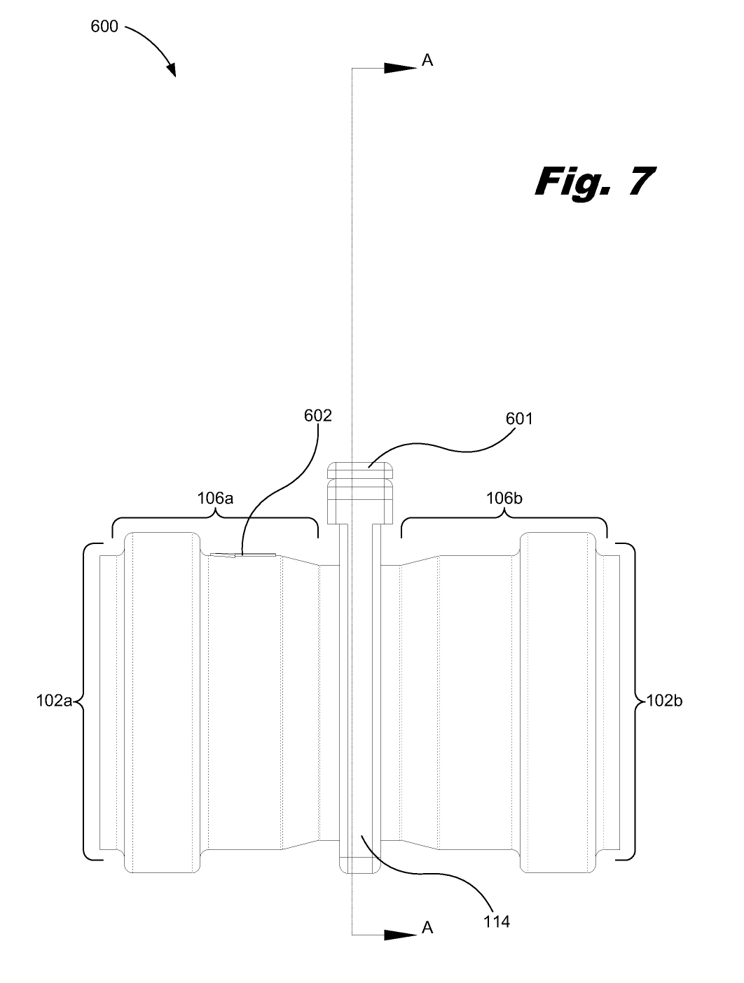

FIG. 7 is a side view of the pipe fitting (600) of FIG. 6 with the gate plug (601) inserted into the gate housing (114), according to one example of the principles described herein. The solid gate (601) may have been previously removed, and the gate plug (601) may have been inserted in to the void defined in the gate housing (114). The gate plug (601) may form a hermetic seal with respect to the gate housing (114), such that water may not flow up and out of the top of the gate housing (114). While the gate plug (601) is present, fluids may flow freely between the first section (106a) and the second sections (106b). In this example, where the solid gate (106) is removed, and the gate plug (601) is inserted, the same function is performed as was described in previous figures where the gate (103) is lifted into the open position. In this example, the gate plug (601) may have the additional advantage of being less cumbersome, use less space than the gate (103) in the folded position, and may also be less prone to failure, such as falling back into the closed position.

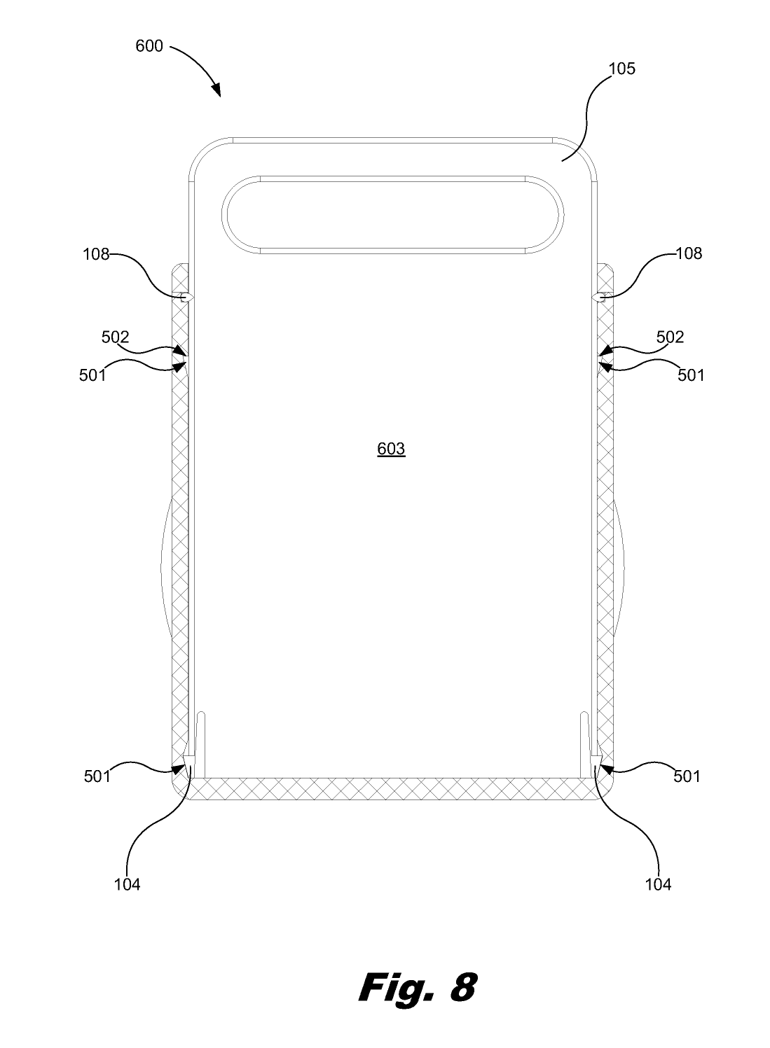

FIG. 8 is a front cut-away view of the pipe fitting (600) along line “A” of FIG. 7, according to one example of the principles described herein. Many of the concepts described previously referring to the gate (103) in the closed position are valid here as well. In this example, as in others, the solid gate (603) while in the closed position, will form a hermetic seal between the first section (106a) and the second section (106b) of the pipe fitting (600) with respect to the gate housing (114), so as to prevent the flow of fluids from one section to the other. The solid gate (603) may also form a seal with respect to the gate housing (114) using a number of gate gaskets (108) which may prevent fluids such as water from escaping through the top of the gate housing. In this example, the solid gate (603) may not comprise the manufactured breakaway (112) described previously. Advantages of this example may include an increase in structural rigidity of the solid gate (603) when compared with the gate (103), especially when in the closed position.

As described previously, this example may also be constructed of a material capable of withstanding a number of different fluidic pressures necessary for a pressurized plumbing system, exerted evenly throughout the interior of the pipe fitting (600). In one example, this may be at least 5 pounds per square inch (psi), a standard pressure used in inspections according to several local ordinances. In another example the maximum pressure may be more or less as described previously. With the solid gate (603) in the closed position an inspector may inspect either section one (106a) or section two (106b) of the pipe fitting independently to the specified pressure.

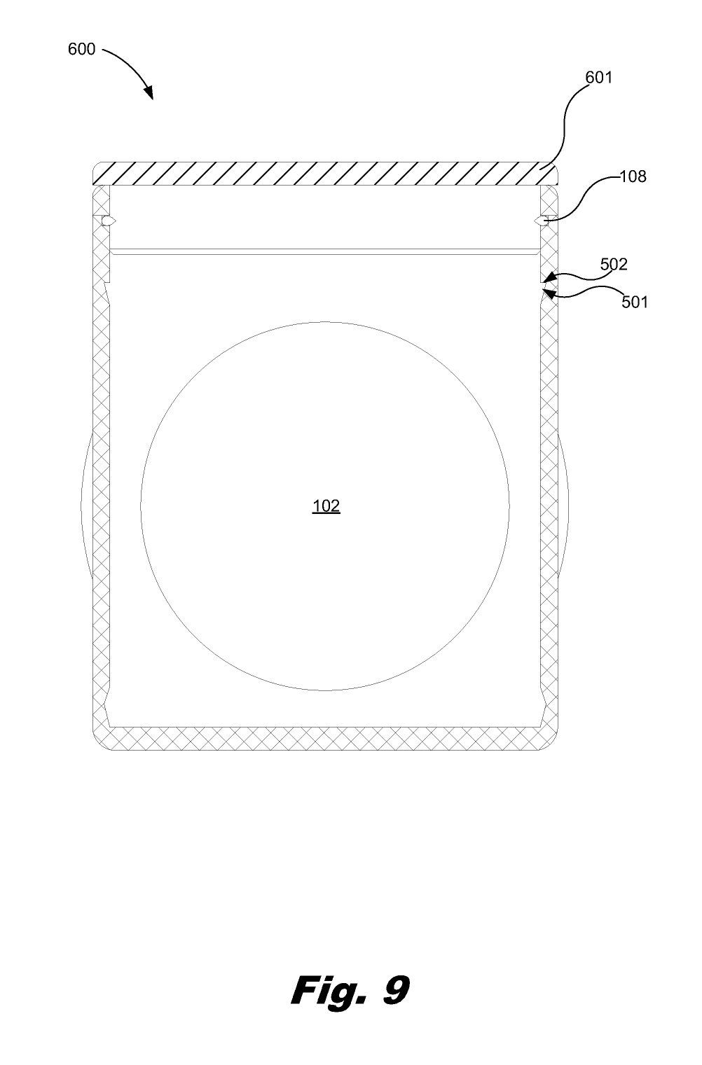

FIG. 9 is a front cut-away view of the pipe fitting (600) along line “A” of FIG. 7 with the gate plug (601) inserted into the void defined in the gate housing (114), according to one example of the principles described herein. In one example, following the inspection process to determine the soundness of the plumbing system attached to the pipe fitting (600) of FIG. 6, the user may wish to remove the solid gate (601) completely and insert a gate plug (601) into the void left behind. The gate plug (601) may create a hermetic seal with respect to the gate housing (114), with a gate gasket (108) completing the seal. The gate plug (601) may provide its own gate gasket in one example, or use the gate gasket (108) left behind by the solid gate (603) in another example. With the gate plug (601) in place, fluids such as water may flow from section one (106a) to section two (106b), or vice-versa, of the pipe fitting (600) unimpeded.

In one example the gate plug (601) will be secured by the compression fitting of the gate housing (114) and gate gasket (108). In another example the gate plug (601) may be secured using a number of plug latches (901) similar to the gate latches (104) found on the solid gate (603), which are biased in an outward direction with respect to the gate plug (601) to create force on the inner walls of the gate housing (114). The plug latches (901) may be secured within the gate latch recesses (501) which assist in securing the gate in an opened or closed position, as described above. In yet another example, the gate plug (601) may be secured to the gate housing (114) through a chemical bonding agent, such as, for example, solvent cements.

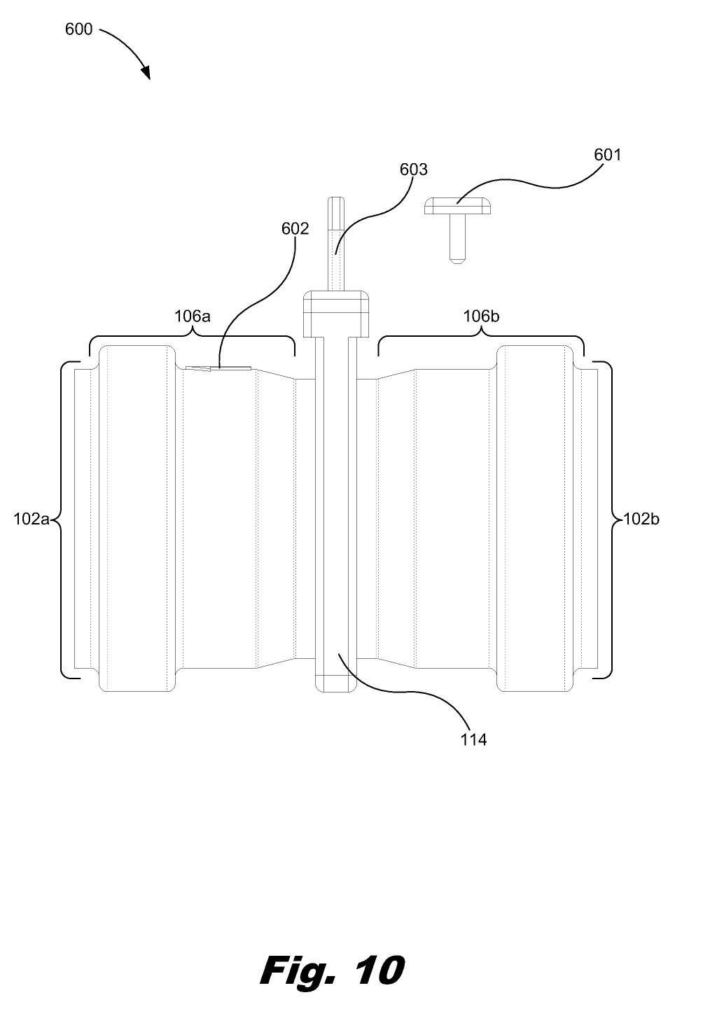

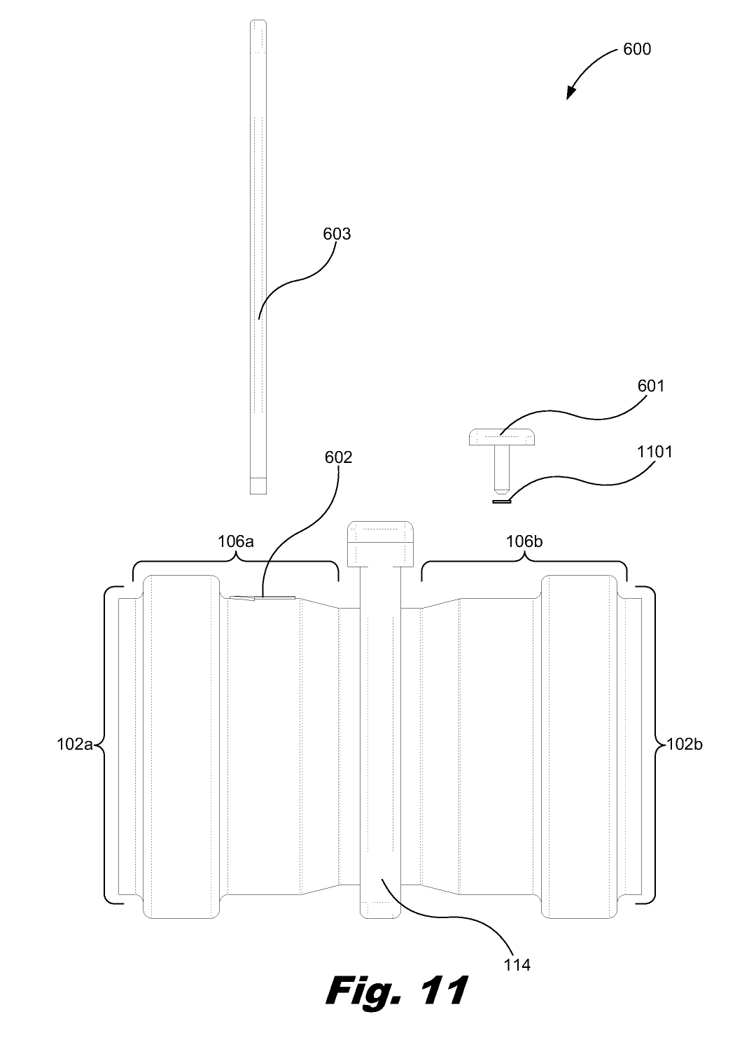

FIG. 10 is a side view of the pipe fitting (600) of FIG. 6 with the solid gate (603) in a closed position, with the gate plug (601) shown outside of the gate housing (114), according to one example of principles described herein. In contrast, FIG. 11 is a side view of the pipe fitting (600) of FIG. 6 with the solid gate (603) removed from the gate housing (114), and the gate plug (601) also outside the gate housing (114) which may be inserted into the void defined within the gate housing (114). The solid gate (603) may be retained within the gate housing (114) by the upper stopping edges (502) depicted in FIG. 9. However, in order to remove the solid gate (603) from the gate housing (114) in order to replace the solid gate (603) with the gate plug (601), the gate latches (104) may be engineered to allow for a user to provide an increased force such that the gate latches (104) may move across the upper stopping edges (502) and removed from the gate housing (114). In one example, the upper stopping edges (502) may be removed or otherwise formed like the gate latch recesses (501) formed in the lower portion of the gate housing (114) depicted in FIG. 5 such that the gate latches (104) may move across the incline of the gate latch recesses (501).

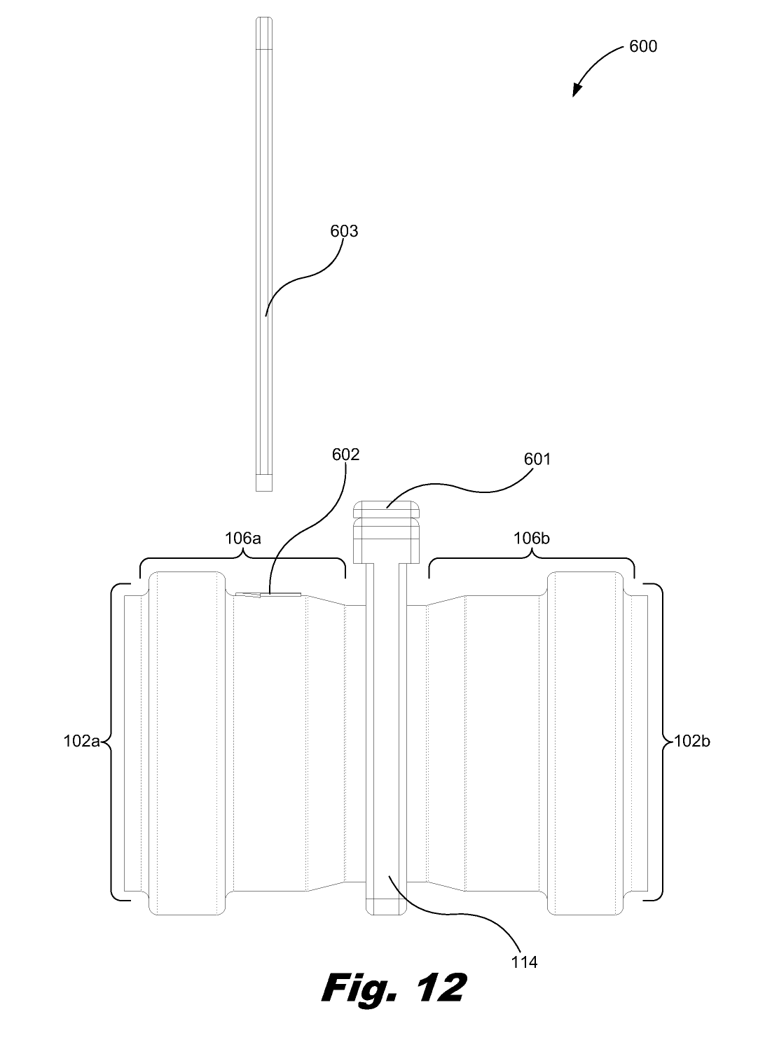

To further contrast, FIG. 12 is a side view of the pipe fitting (600) of FIG. 6 with the solid gate (603) removed from the gate housing (114) and the gate plug (601) inserted into the gate housing (114). These figures together represent one example of a manner in which the solid gate (603) may be removed from the gate housing (114) and the gate plug (601) inserted in its place. In FIG. 10 and FIG. 12 there is a hermetic seal which prevents fluids in a pressurized plumbing system from escaping out of the top of the gate housing (114). Both the solid gate (603) and the gate plug (601) may form a seal with respect to the gate housing (114) by way of a number of gate gaskets (108), in one example. In FIG. 10, fluids are prevented from flowing from section one (106a) to section two (106b), and vice versa of the pipe fitting (600), whereas in FIG. 12 fluids are free to flow back and forth with no resistance. In one example, the directional indicator (602) may be used to represent the downstream direction. In another example, the directional indicator (602) may be used to represent the upstream direction.

In the examples described herein in connection with the gate plug (601), the gate plug (601) may be coupled to the gate housing (114) using a number of coupling methods or devices. For example, latches, chemical bonds, compression fitting, clamps, screws, or combinations thereof may be used couple and/or seal the gate plug (601) to the gate housing (114).

In another example, a number of gaskets (1101) may be coupled to the gate plug (601) in addition to or in place of the gate gaskets (108) depicted in FIG. 8. In this manner, the gate plug (601) may be coupled to the gate housing (114) through the interference fit created by the additional gaskets (1101), and sealed via the gaskets (108, 1101).

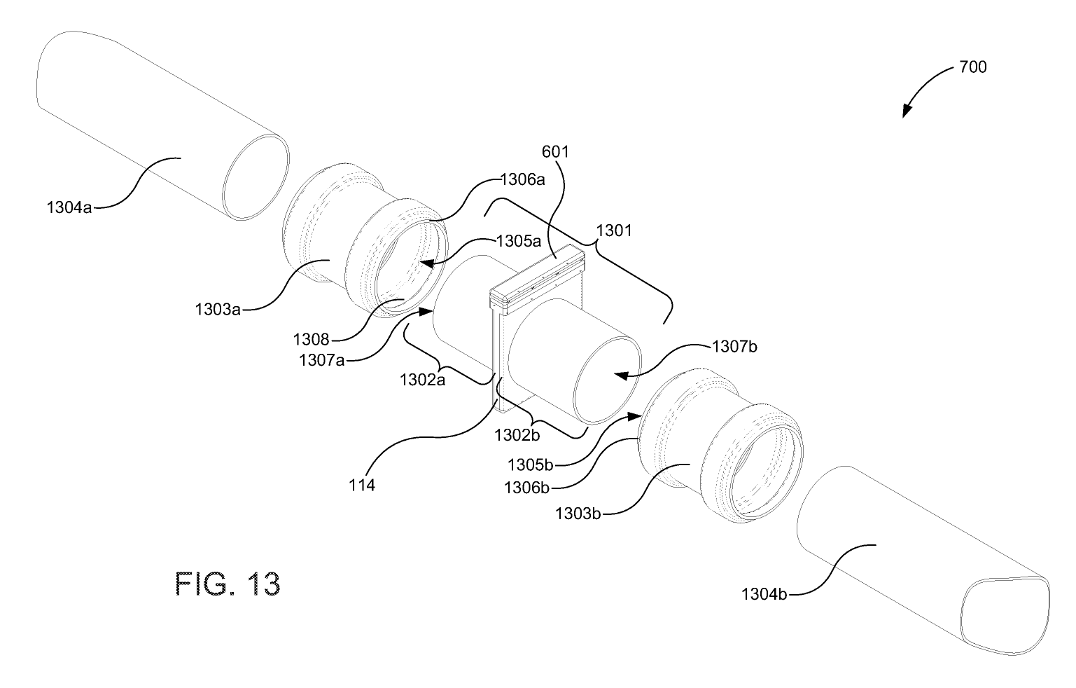

FIG. 13 a front perspective view of the pipe fitting (1301) similar to the pipe fittings (100, 600) of FIGS. 1 and 6, which uses couplers on the ends of the pipe fitting (1301) to connect to upstream (1304a) and downstream (1304b) pipes, according to one example of the principles described herein. In one example, a number of connecting ends (1302a, 1302b), referred herein collectively as 1302, may receive lengths of pipe (1304a, 1304b), referred herein collectively as 1304. The connecting ends (1302) may be the same geometry as the lengths of pipe (1304), and are mated using a pipe coupler (1303a, 1303b), referred herein collectively as 1303. The pipe fitting (100) may selectively couple with the lengths of pipe (1304) by means of the pipe coupler (1303).

In one example, the connecting ends (1302) may have the same geometry as the lengths of pipe (1304), and the pipe coupler (1303) connects both pipes to one another. Geometry being defined herein as the measurements of the connecting ends (1302) and lengths of pipe (1304), and may include but is not limited to inner radius, outer radius, length, inner diameter, outer diameter, material thickness or any combination thereof. In another example, the connecting ends (1302) may be of different geometry as the lengths of pipe (1304). In this case, the pipe coupler (1303) may serve as a means of adapting the sizes of the two pipes so that they may be mated. In some cases it may be advantageous to change the size of the pipe from the upstream pipe (1304a) to the downstream pipe (1304b), and in this way the pipe fitting (1301) may provide the means to perform this function as well.

The pipe fitting (1301) discussed herein may be formed to couple with any diameter, length, or size of pipe (1304). Thus the connecting ends (1302) may be of any diameter to couple with any diameter, length, or size of pipe (1304), as discussed above. The connecting ends (1302) may be of any thickness necessary to perform the function of containing a reasonable pressure distributed evenly throughout the inside of the pipe system (700).

The connecting ends (1302) may be permanently attached to the pipe coupler (1303) in a number of ways, many of which have been discussed above. In one example, a chemical bonding agent, such as a solvent cement may be used. In another example, a compression fitting using a number of gaskets may be used. The gaskets may be located in a number of gasket recesses (1308) defined within the standard pipe coupler (1303). In another example, the permanent connection may be provided through a heat-fusion process such as a butt-fusion process.

The pipe fitting (1301) of FIG. 13 provides the user with additional versatility in design. It simplifies the design of the pipe fitting (1301) itself and increases the use of standard components in the system in which the pipe fitting (1301) is used.

The pipe fitting (100) and each of the examples described herein may be sold and packaged separately, together, or in groups, in any composition. In one example, the pipe fitting (600) of FIG. 6 may be sold as a kit with the pipe fitting (600), solid gate (603) and gate plug (601) included as separate components in a single kit. In another example, the pipe fitting (600) and solid gate (603) may be sold together as a kit, with the gate plug (601) provided separately. In yet another example, the pipe fitting (600), solid gate (603), and gate plug (601) may be sold separately. Any of the sections, components, or pieces described herein may be sold separately or together in a kit with any other sections, components, or pieces.

The preceding description has been presented to illustrate and describe examples of the principles described. This description is not intended to be exhaustive or to limit these principles to any precise form disclosed. Many modifications and variations are possible in light of the above teaching.

What is claimed is:

1. A pipe fitting comprising:
a number of orifices defined in a number of connecting ends;
a gate housing dividing the pipe fitting into a first section and a second section;
a gate disposed within the gate housing to selectively seal the first section from the second section; and
a gate plug to selectively seal the gate housing upon removal of the gate from the gate housing.

2. The pipe fitting of claim 1, in which the connecting ends further comprise a number of gasket recesses defined in the connecting ends, in which the gasket recesses comprise a number of gaskets for connecting lengths of pipe to the pipe fitting.

3. The pipe fitting of claim 2, in which the gaskets hermetically seal the pipe fitting with respect to the connecting lengths of pipe.

4. The pipe fitting of claim 1, in which connecting ends of the pipe fitting are formed to allow the creation of a connection with a number of lengths of pipe.

5. The pipe fitting of claim 1, in which the connecting ends of the pipe fitting are dimensioned to couple with pipe couplers.

6. The pipe fitting of claim 1, in which the gate further comprises a number of gate latches to lock the gate in an open, closed, or intermediary position.

7. The pipe fitting of claim 6, in which the gate latches of the gate engage with a number of recesses defined in the wall of the pipe fitting.

8. The pipe fitting of claim 7, further comprising a stopping edge defined in a number of recesses used to secure the gate in an open position.

9. The pipe fitting of claim 8, in which the gate may be removed from the gate housing through the application of force by the user to overcome the force applied by the stopping edge, and be replaced with the gate plug.

10. The pipe fitting of claim 9, further comprising a number of gaskets to seal the connection between the gate plug and the gate.

11. The pipe fitting of claim 1, further comprising a number of couplers to couple the gate plug to the gate housing, the couplers comprising latches, chemical bonds, compression fitting, clamps, or screws.

12. The pipe fitting of claim 1, further comprising a number of gate gaskets to hermetically seal the gate with respect to the pipe fitting.

13. The pipe fitting of claim 12, in which a number of gate gaskets are located between the gate housing and the gate.

14. The pipe fitting of claim 1, in which the length of pipe is constructed of a transparent material.

15. A pipe fitting comprising:
a number of orifices defined in a number of connecting ends;
a gate housing dividing the pipe fitting into a first section and a second section;
a removable gate within the gate housing to selectively seal the first section from the second section; and
a gate plug to seal the gate housing upon removal of the removable gate,
in which the gate plug is dimensioned to seal the gate housing.

16. The pipe fitting of claim 15, in which the gate further comprises a number of gate latches to lock the gate in an open, closed, or intermediary position.

17. The pipe fitting of claim 16, in which the gate latches of the gate engage with a number of recesses defined in the wall of the pipe fitting.

18. The pipe fitting of claim 15, in which at least portions of the pipe fitting are constructed of transparent material.

19. A pipe fitting comprising:
a gate housing dividing the pipe fitting into a first section and a second section; and
a gate within the gate housing to selectively seal the first section from the second section, the gate being removable from the gate housing; and
a gate plug to seal the gate housing upon removal of the gate from the gate housing.

20. The pipe fitting of claim 19, in which the gate plug may be inserted into the void defined in the gate housing which remains after the removal of the solid gate, and hermetically seals the pipe fitting.
